(19) United States
(12) Patent Application Publication
(10) Pub. No.: US 2013/0102216 A1
(43) Pub. Date: Apr. 25, 2013

(54) INFRARED-REFLECTIVE TWO-PART COATING COMPOSITION

(71) Applicants: Heidi M. Turner, Rosemount, MN (US); Glen O. Vetter, New Hope, MN (US); Andrea Anderson, Minneapolis, MN (US); Wallace Kesler, Burnsville, MN (US)

(72) Inventors: Heidi M. Turner, Rosemount, MN (US); Glen O. Vetter, New Hope, MN (US); Andrea Anderson, Minneapolis, MN (US); Wallace Kesler, Burnsville, MN (US)

(73) Assignee: VALSPAR SOURCING, INC., Minneapolis, MN (US)

(21) Appl. No.: 13/700,079

(22) PCT Filed: Jul. 1, 2011
(86) PCT No.: PCT/US11/42801

§ 371 Date: Nov. 26, 2012

Related U.S. Application Data
(60) Provisional application No. 61/360,804, filed on Jul. 1, 2010.

(30) Foreign Application Priority Data
Jul. 1, 2010 (US) 61360804

(51) Int. Cl. C09D 5/32

(52) U.S. Cl. CPC C09D 5/32
USPC 442/132; 252/587; 427/160; 428/423.1; 428/424.2; 428/424.8; 428/424.7; 428/412; 428/423.5; 428/423.7

(57) ABSTRACT

Articles containing thermoplastic, thermoplastic composite or thermoplastic-clad materials are made less susceptible to heat distortion by coating the article with a two-part aqueous coating composition whose first part contains a waterborne active hydrogen-functional latex binder and whose second part contains a water-dispersible polyisocyanate. One or both of the first and second parts contain non-infrared-absorptive colored pigment. A mixture of the first and second parts coated atop a vinyl substrate cures to form a vinyl-adherent, infrared-reflective colored protective film.

### CROSS-REFERENCE TO RELATED APPLICATION

This application claims priority to U.S. Provisional Application Ser. No. 61/360,804 filed 1 Jul. 2010, the disclosure of which is incorporated herein by reference.

### FIELD

This invention relates to infrared-reflective coatings.

### BACKGROUND

The increased use of energy-efficient windows has led to unintended problems when light reflects off the window glazing onto nearby thermoplastic building components. For example, building components such as siding, door moldings, window moldings and decking are often made with or clad with vinyl thermoplastics. Vinyls typically have low heat distortion temperatures of about 70-75° C. Ordinary sunlight can cause thermoplastic building components and especially vinyl building components in the path of reflected light rays to undergo heat distortion, melting or premature aging. Objectionable and sometimes permanent damage may consequently occur in thermoplastic building components situated on or near buildings equipped with energy-efficient windows. In some cases the damage may even extend to thermoplastic building components located on neighboring properties.

Thermoplastic, thermoplastic composite and thermoplastic-clad building components desirably should also withstand other outdoor conditions including rain, wind, snow and temperature extremes. To help them do so, building component manufacturers may in some instances apply a protective topcoat (e.g., a paint) to a newly-manufactured building component before the component is shipped to a building site. In recent years, paints designed for application onto installed thermoplastic building components (e.g., paints for vinyl siding) have also become available. Whether applied at a manufacturing site or onto an existing installed building component, it can be difficult to provide adequate protective coatings on many thermoplastics. For example, vinyl has a low surface energy and a high coefficient of thermal expansion, and consequently it can be very difficult to formulate vinyl paints with adequate adhesion and durability.

Thermoplastic building components are sometimes combined with thermoset, wood-containing or wood-derived building components to form windows, doors and other assemblies. The assembly manufacturer may desire to apply a finish to all of the building components in the assembly, and to use a single coating composition when doing so.

From the foregoing, it will be appreciated that what is needed in the art are coating compositions that will adhere well to and yet protect thermoplastic, thermoset, wood-containing and wood-derived building components. Such compositions and methods for their use are disclosed and claimed herein.

### SUMMARY OF THE INVENTION

The present invention provides, in one aspect, a two-part aqueous coating composition whose first part comprises a waterborne active hydrogen-functional latex binder and whose second part comprises a water-dispersible polyisocyanate, wherein one or both of the first and second parts comprise non-infrared-absorptive colored pigment, and wherein a mixture of the first and second parts coated atop a vinyl substrate will cure to form a vinyl-adherent, infrared-reflective colored protective film.

The invention provides, in another aspect, a coated building component comprising a thermoplastic, thermoplastic-containing or thermoplastic-clad substrate having thereon a wet coating comprising a waterborne mixture of active hydrogen-functional latex binder, water-dispersible polyisocyanate and non-infrared-absorptive colored pigment, which coating will cure to form a substrate-adherent and infrared-reflective colored protective film.

The invention provides, in yet another aspect, a method for coating building components, which method comprises:
a) applying to a building component comprising a thermoplastic, thermoplastic composite or thermoplastic-clad substrate a wet coating comprising a waterborne mixture of active hydrogen-functional latex binder, water-dispersible polyisocyanate and non-infrared-absorptive colored pigment; and
b) curing the coating to form a substrate-adherent and infrared-reflective colored protective film.

The disclosed composition and method provide a cured protective film that reduces susceptibility of infrared-illuminated thermoplastic building components to heat distortion compared to an otherwise similar film made without such non-infrared-absorptive colored pigment.

### BRIEF DESCRIPTION OF THE DRAWING

FIG. 1 is a schematic cross-sectional view of a coated article of the invention.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a coating composition that contains “an” additive means that the coating composition includes “one or more” additives.

The terms “architectural paints” and “architectural stains” respectively mean paints and stains for use on interior or exterior building components.

The term “binder” means a film-forming natural or synthetic polymer suitable for use in a paint or stain.

The term “building component” means an unattached article intended for installation and use on or as a part of a building or other architectural object or structure (e.g., windows, doors, siding, shutters, trim, moldings, jambs, decking, railings, roofing, walls, floors, ceilings, etc.) but not yet installed thereon.

The term “colorant” means a composition that may be added to a base paint or stain so as to alter the hue or lightness of such base paint or stain, and which contains pigment or dye and an optional vehicle but is substantially free of binder.

The term “colored” when used with respect to a pigment or colorant means having a color other than white, e.g., having a hue such as red, green, blue or yellow. Black pigments or colorants will also be deemed to be colored for purposes of the present invention.

The term “dark-colored” when used with respect to a paint or stain means that the paint or stain has an L* value less than 60 as determined by casting a 25 μm dry thickness coating film over the white part of a BYK-Gardner No. PA-2811 opacity drawdown chart (from BYK-Gardner USA) or comparable chart, and measuring L* as defined in the ASTM International Standards on Color and Appearance Measurement: 8th Edition.

The term “low VOC” when used with respect to a liquid coating composition means that the coating composition contains less than about 10 wt. % volatile organic compounds, more preferably less than about 7% volatile organic compounds, and most preferably less than about 4% volatile organic compounds based upon the total liquid coating composition weight.

The terms “non-infrared-absorptive” and “infrared reflective” when used with respect to a paint or stain means that the paint or stain when cast as an at least 40 μm dry thickness coating film over the black part of the above-mentioned BYK-Gardner opacity drawdown chart will have a total solar reflectance (TSR) of at least 10 as measured using the procedure of ASTM E-971-88 (Reapproved 2003). TSR is a measure of the total percentage of incident solar radiation reflected by an object, and a 10 TSR value means that 10% of the total solar radiation is reflected by the object. The term “non-infrared-absorptive” when used with respect to a pigment or colorant means that when sufficient such pigment or colorant is added to a clear base paint so as to provide an opaque (as defined below) film when cast as an at least 40 μm dry thickness coating film over the white and black parts of the above-mentioned BYK-Gardner opacity drawdown chart, the dry film will have a TSR of at least 10 as measured over the white part of the drawdown chart.

The term “opaque” when used in respect to a dry coating film means that the film has a contrast ratio greater than 95%. The contrast ratio is determined by dividing the L* value measured over the black portion of the above-mentioned BYK-Gardner opacity drawdown chart by the L* value measured over the white portion.

The term “paint” means a coating composition including pigment and binder which when applied to form a thin (e.g., 100 μm) wet thickness coating film on a freshly-sanded smooth wood surface, will when dried hide both the wood grain and its texture and will present a new surface with its own appearance.

The term “pigment” includes not only particulate pigments that function by reflecting light but also soluble or dispersible dyes that function by absorbing light.

The term “pigment volume concentration” when used in respect to a paint, stain or colorant means the total percentage of dried coating volume occupied by all pigment species in the coating.

The terms “polymer” and “polymeric” include polymers as well as copolymers of two or more monomers.

The term “pot life” means the time period during which a mixture of the disclosed first and second parts may be stored before the mixture gels sufficiently to cause a significant reduction in coating quality when the mixture is applied to a desired substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “solvent-borne” when used in respect to a paint, stain or colorant means that the major liquid vehicle or carrier for the paint, stain or colorant is a nonaqueous solvent or mixture of nonaqueous solvents.

The term “stain” means a coating composition including binder which when applied to form a thin (e.g., 100 μm) wet thickness coating film on a freshly-sanded smooth wood surface, will when dried not hide both the wood grain and its texture. When a semi-transparent stain is applied to wood, the wood grain and its texture normally both remain noticeable, whereas when a solid color (viz., opaque) stain is applied the grain normally becomes hidden while the texture normally remains noticeable. A stain typically will soak into a wood or other porous substrate to a much greater extent than will a paint.

When used with respect to a component which may be found in a paint, stain or colorant composition, the term “substantially free of” means containing less than about 1 wt. % of the component based on the composition weight.

The term “topcoat” refers to a coating composition which when dried or otherwise hardened provides a decorative or protective outermost finish layer on a coated substrate. By way of further explanation, such topcoats may be applied in one or more layers and may be applied to bare or primer-coated substrates. The term “primer” refers to a coating composition that is applied in one or more layers to a bare substrate and which if left uncoated without a topcoat would not be capable of withstanding extended outdoor exposure (e.g., exposure equivalent to one year of vertical south-facing Florida sunlight) without visually objectionable deterioration.

The term “vinyl” means a polyvinyl chloride polymer or copolymer.

The term “waterborne” when used in respect to a paint, stain or colorant means that the major liquid vehicle or carrier for the paint, stain or colorant is water.

The term “water-dispersible” when used in respect to a polyisocyanate refers, as the context may require, to such a polyisocyanate either before or after it is dispersed in water.

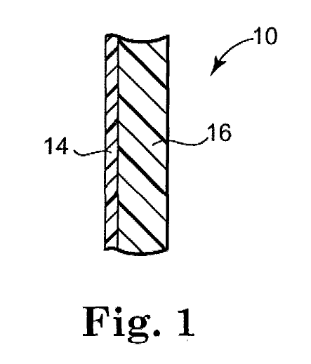

Referring to FIG. 1, a coated building component 10 of the invention is shown in schematic cross-sectional view. Building component 10 includes a substrate-adherent and infrared-reflective coating 14 made from the disclosed two-part composition atop a thermoplastic (e.g., vinyl) substrate 16. Coating 14 may be applied to substrate 16 in one or more layers which may be the same as or different from one another. Coating 14 desirably is both decorative and weather-resistant, and may be applied to building component 10 at the location where substrate 16 is manufactured, at an intermediate location, at a location where building component 10 will be eventually be installed (e.g., before building component 10 is attached to a building or other architectural object or structure), or after building component 10 has been so attached. Persons having ordinary skill in the art will appreciate that building component 10 may have a variety of shapes, sizes and end uses.

A variety of active hydrogen-functional latex binders (sometimes referred to as the primary resin) may be used in the disclosed coating compositions. Exemplary such binders typically will contain at least active-hydrogen functional latex particles (e.g., particles of a functionalized acrylic polymer), water and one or more surfactants, and may contain additional ingredients that will be familiar to persons having ordinary skill in the art. Representative active hydrogen-functional latex binders include EPS 2771 acrylic emulsion from EPS Corp., RHOPLEX™ AC-1020 acrylic emulsion from Rohm and Haas Co.; RHOSHIELD™ 3275 polymer dispersion from Rohm and Haas Co.; ALBERDINGK™ AC 2514 polymer dispersion from Alberdingk Boley, Inc.; JONCRYL™ 1987 and JONCRYL 8383 acrylic emulsions from BASF Corp.; and mixtures thereof. Preferably the coating compositions contain about 20 to about 70 wt. % and more preferably about 40 to about 50 wt. % active hydrogen-functional latex binder solids based on total solids.

A variety of water-dispersible polyisocyanates may be used in the disclosed coating compositions. Exemplary such polyisocyanates typically will be at least difunctional, be dispersible in water via stirring or if need be via the use of more energetic mixing such as a high shear mixer, and will have at least limited storage stability when so dispersed. As supplied, the polyisocyanate may contain additional ingredients (e.g., solvents, thickeners or other viscosity-modifying substances) that will be familiar to persons having ordinary skill in the art. The crosslinker may be a monomer, oligomer or polymer and preferably is a monomer or oligomer. Representative water-dispersible polyisocyanates include BAYHYDUR™ 302, BAYHYDUR 303, BAYHYDUR 304 and BAYHYDUR 305 from Bayer MaterialScience; EASAQUA™ X D 401 from the Perstorp Group; and mixtures thereof. Preferably the coating compositions contain about 1 to about 10 wt. % and more preferably about 4 to about 6 wt. % polyisocyanate based on total solids.

A variety of non-infrared-absorptive colored pigments may be used in the coating compositions. Exemplary such pigments may be inorganic or organic in nature, and include but are not limited to those referred to in U.S. Pat. Nos. 6,458,848 B2 (Sliwinski et al.), 6,616,744 B1 (Sainz et al.), 6,989,056 B2 (Babler) and 7,157,112 B2 (Haines) and in U.S. Patent Application Publication No. US 2005/0126441 A1 (Skelhorn). Inorganic pigments are especially desirable and include single or mixed metal oxides formed from a variety of metals, e.g., from aluminum, antimony, bismuth, boron, chromium, cobalt, gallium, indium, iron, lanthanum, lithium, magnesium, manganese, molybdenum, neodymium, nickel, niobium, silicon, tin, vanadium or zinc. Exemplary metal oxides include Cr₂O₃, Al₂O₃, V₂O₃, Ga₂O₃, Fe₂O₃, Mn₂O₃, Ti₂O₃, In₂O₃, TiBO₃, NiTiO₃, MgTiO₃, CoTIO₃, ZnTiO₃, FeTiO₃, MnTiO₃, CrBO₃, NiCrO₃, FeBO₃, FeMoO₃, FeSn(BO₃)₂, BiFeO₃, AlBO₃, Mg₃Al₂Si₃O₁₂, NdAlO₃, LaAlO₃, MnSnO₃, LiNbO₃, LaCoO₃, MgSiO₃, ZnSiO₃, Mn(Sb,Fe)O₃ and mixtures thereof. The metal oxide may have a corundum-hematite crystal lattice structure as described in the above-mentioned U.S. Pat. No. 6,454,848 B2, or may be a host component having a corundum-hematite crystalline structure which contains as a guest component one or more elements selected from aluminum, antimony, bismuth, boron, chromium, cobalt, gallium, indium, iron, lanthanum, lithium, magnesium, manganese, molybdenum, neodymium, nickel, niobium, silicon, tin, vanadium and zinc. Black non-infrared-absorptive pigments are of particular interest due to the high infrared absorption of conventional carbon black pigments and the widespread use of carbon black pigments in conventional dark-tinted paints and stains. A variety of black non-infrared-absorptive pigments are commercially available, including mixed metal oxide pigments such as those supplied by Ferro Corporation under the COOL COLORS™ and ECLIPSE™ trademarks, for example V-778 COOL COLORS IR Black, V-780 COOL COLORS IR Black, V-799 COOL COLORS IR Black, 10201 ECLIPSE Black, 10202 ECLIPSE Black and 10203 ECLIPSE Black; mixed metal oxide pigments such as those supplied by Shepherd Color Company under the ARTIC™ trademark, for example ARTIC Black 376, ARTIC Black 10C909, ARTIC Black 411 and ARTIC Black 30C940; mixed metal oxide pigments such as those supplied by Tomatec America, Inc. under the numbers 42-707A and 707V10; and perylene-based or other organic colorants such as those supplied by BASF Corp. under the PALIOGEN™ trademark including PALIOGEN Black S 0084. These same and other suppliers also provide non-infrared-absorptive colored pigments in a variety of hues other than black, often under the same trademarks, and these may likewise be employed in the disclosed coating compositions. As is the case with black pigments, non-infrared-absorptive pigments in dark colors such as brown, dark green and dark blue are of particular interest due to the high infrared absorption of their conventional counterpart pigments. Exemplary non-infrared-absorptive non-black pigments include inorganic pigments such as iron oxide, chromic oxide, magnesium silicates, calcium carbonate, aluminosilicates, silica and various clays (e.g., chromic oxide green G-6099 from Elementis Specialties); organic pigments including plastic pigments such as solid bead pigments (e.g., polystyrene or polyvinyl chloride beads); and microsphere pigments containing one or more voids (e.g., those discussed in U.S. Patent Application Publication No. US 2007/0043162 A1 (Bardman et al.). Other exemplary non-infrared-absorptive pigments include EXPANCEL™ 551DE20 acrylonitrile/vinyl chloride expanded particles (from Expancel Inc.), SIL-CEL™ 43 glass micro cellular fillers (from Silbrico Corporation), FILLITE™ 100 ceramic spherical particles (from Trelleborg Fillite Inc.), SPHERICEL™ hollow glass spheres (from Potter Industries Inc.), 3M ceramic microspheres including grades G-200, G-400, G-600, G-800, W-210, W-410, and W-610 (from 3M); 3M hollow microspheres including 3M Performance Additives iM30K (also from 3M), INHANCE™ UH 1900 polyethylene particles (from Fluoro-Seal Inc.), and BIPHOR aluminum phosphate (from Bunge Fertilizantes S.A., Brazil). The disclosed coating compositions may also contain non-infrared-absorptive non-colored pigments such as titanium dioxide and white zinc oxide, either of which if used without the presence of a colored pigment would provide a white rather than colored coating composition. The addition of such non-colored pigments to the above-mentioned non-infrared-absorptive colored pigments can provide tinted paints and stains having a lightened shade and improved hiding power. Preferably the disclosed coating compositions contain about 8 to about 50 wt. % and more preferably about 20 to about 30 wt. % pigment based on total solids, and with the pigment being added to the disclosed first part, second part or to both the first and second parts. Expressed on the basis of pigment volume concentration, the disclosed coating compositions preferably contain about 10 to about 40% and more preferably about 15 to about 20% pigment. The compositions desirably are free of or substantially free of infrared-absorptive colored pigments, e.g., carbon black, black iron oxide, brown oxide and raw umber.

The coating compositions contain water, which may be tap, deionized, distilled, reverse osmosis or recycled water. Preferably the coating compositions contain sufficient water so that about 20 to about 80 wt. % solids and more preferably about 35 to about 65 wt. % solids are present when the composition is applied to a substrate. The coating compositions may also contain one or more cosolvents or plasticizers to assist in mixing or coating the composition; to improve coalescence; to speed up, reduce the required heat or reduce emissions associated with forced drying; or to facilitate air drying. The cosolvents preferably are non hazardous air pollutant solvents (non-HAPS solvents), may where appropriate be obtained in a water-free (e.g., urethane grade) form, and may for example include glycol ethers (e.g., DOWANOL™ DPM and Butyl CELLOSOLVE™ from Dow Chemical Co.), ketones (e.g., acetone, methyl ethyl ketone, methyl propyl ketone, methyl amyl ketone and M-PYROL™ N-methyl 2-pyrrolidone from International Specialty Products), alcohols (e.g., ethanol and isopropyl alcohol), acetates (e.g., methyl acetate, ethyl acetate, dipropyl acetate, isobutyl acetate and t-butyl acetate), the various glycol solvents discussed in International Application No. WO 2008/150294 A1 (Foster et al. to Valspar Sourcing), and mixtures thereof. The coating compositions preferably contain 0 to about 100 and more preferably less than about 30 g/L cosolvent, with the cosolvent being added to the disclosed first part, second part or preferably to both the first and second parts. Exemplary plasticizers include CARBOWAX™ 300 and CARBOWAX 600 polyethylene from Dow Chemical Co., PARAPLEX™ G-30, PARAPLEX G-41, PARAPLEX G-60, PARAPLEX RGA-2 and PARAPLEX WP-1 from Dow Chemical Co., CITROFLEX™ 4 citric acid ester from Vertellus Specialties Inc., and mixtures thereof. The coating compositions preferably contain 0 to about 10 wt. % and more preferably about 2 to about 5 wt. % plasticizer based on the total composition weight, and with the plasticizer being added to the disclosed first part, second part or to both the first and second parts.

The coating compositions may contain additional ingredients. For example, the compositions may contain one or more non-hydroxyl-functional resins (sometimes referred to as secondary resins) which may serve to modify the properties of the coating composition before or after it is applied to a substrate. Exemplary such secondary resins preferably are waterborne resins or emulsions and may for example include KYNAR™ AQUATEC™ ARC fluoropolymer emulsion from Arkema and LUMIFLON™ FE4300 and LUMIFLON FE4400 fluoropolymer emulsions from Asahi Glass Company. When the coating compositions contain a secondary resin, the amount may for example be about 1 to about 50 wt. % and more preferably about 5 to about 35 wt. % secondary resin based on total solids, and with the secondary resin being added to the disclosed first part, second part or to both the first and second parts.

The coating compositions may contain additional reactive monomers, oligomers or polymers together with suitable crosslinkers, catalysts or initiators. For example, the addition of a catalyst may facilitate curing of the colored protective film, provide a reduction in tack-free time, or improve early hardness attainment or blocking resistance. This may for example enable earlier stacking of coated parts, but may also reduce pot life. Desirably the catalyst addition is sufficient to reduce tack-free time while still providing a pot life of at least about 20 minutes. Exemplary catalysts include iron catalysts such as BORCHI™ OXY-Coat and tin catalysts such as BORCHERS™ LH-10, both from OMG Borchers GmbH. When a catalyst is present, the coating compositions preferably contain about 0.1 to about 4 wt. % and more preferably about 0.2 to about 2 wt. % catalyst based on the total composition weight, and with the catalyst preferably being added to the disclosed first part, or to the second part or to both the first and second parts.

The coating compositions may contain thickeners and other rheology modifiers (e.g., sedimentation inhibitors). Exemplary thickeners include hydrophobic ethoxylated urethane resin (HEUR) thickeners, hydrophobically-modified, alkali-soluble or alkali-swellable emulsion (HASE) thickeners), cellulosic thickeners, polysaccharide thickeners and mixtures thereof. Exemplary commercially-available thickeners include ACRYSOL™ RM-8, RM-12W and RM-2020 all from Rohm & Haas, ATTAGEL™ 50 from BASF Corp., BENTONE™ AD and BENTONE EW both from Elementis Specialties, CELLOSIZE™ QP-09-L from Dow Wolff Cellulosics and NATROSOL™ 250 from Hercules Inc. When a thickener is present, the coating compositions preferably contain about 0.1 to about 3 wt. % and more preferably about 0.5 to about 3 wt. % thickener based on total composition weight, and with the thickener being added to the disclosed first part, second part or to both the first and second parts.

The coating compositions may contain surfactants or dispersants (aside from those which already may be present in the latex binder or the polyisocyanate). Exemplary surfactants or dispersants include anionic, cationic, amphoteric and nonionic materials. Commercially-available surfactants or dispersants include DISPERBYK™-190 from Altana, EFKA™ 4510 from BASF, HYDROPALAT™ 44 from Cognis, RHODAPEX™ CO-430 and RHODAPEX CO-436 from Rhodia, TAMOL™ 165A and TAMOL 731 A both from Rohm & Haas, and T-DET™ N 10.5 from Harcros Chemicals Inc. When a surfactant or dispersant is present, the coating compositions preferably contain about 0.1 to about 10 wt. % and more preferably about 1 to about 3 wt. % surfactant or dispersant based on the total composition weight, and with the surfactant or dispersant being added to the disclosed first part, second part or to both the first and second parts.

The coating compositions may contain a variety of other adjuvants that will be familiar to persons having ordinary skill in the art. Representative adjuvants are described in Koleske et al., Paint and Coatings Industry, April, 2003, pages 12-86. Exemplary adjuvants and commercial examples of the same include anti-cratering agents, biocides (e.g., BUSAN™ 1292 from Buckman Laboratories, Inc., NOPCOCIDE™ N-40D from Cognis, and POLYPHASE™ 663 or POLYPHASE 678 both from Troy Corporation), coalescents, curing indicators, defoamers (e.g., FOAMASTER™ 111 and FOAMASTER 333 both from Cognis, and TEGO™ FOAMEX™ 810 from Evonik), fillers, flatting agents (e.g., talcs, silicas, silicates and wollastonites such as VANSIL™ fillers from R.T. Vanderbilt), insulating fillers such as ZEEOSPHERES™ ceramic microspheres from Zeeospheres Ceramics, LLC, heat stabilizers, leveling agents, light stabilizers (e.g., hindered amine light stabilizers such as TINUVINT™ 123-DW and TINUVIN 292 HP from Ciba Specialty Chemicals), mildewcides, optical brighteners, plasticizers, preservatives (e.g., KATHON™ LX from Rohm & Haas), ultraviolet light absorbers (e.g., TINUVIN 234 and TINUVIN 1130 from Ciba Specialty Chemicals, and EVERSORB™ 80 from Everlight Chemical), waxes (e.g., AQUACER™ 593 from Altana, HYDROCER™ 303 from Shamrock Technologies, Inc. and MICHEM™ Emulsion 32535 from Michelman, Inc.), wetting agents (e.g., BYK™ 346 and BYK 348 from Altana, and TROYSOL LAC™ from Troy corporation), and the like. The types and amounts of these and other adjuvants typically will be empirically selected for use with the particular application and curing equipment at a given manufacturing site, and with the adjuvant being added to the disclosed first part, second part or to both the first and second parts.

The first and second parts may be packaged in any convenient packaging suitable for storing a desired quantity of each component without leading to premature gelation, undue separation or other undesirable degradation during storage. Exemplary containers include cans, pails, bottles, drums, totes and tanks. The first and second parts typically will be kept separate from one another until shortly before use, then mixed together and applied to a desired building component. The mixing ratio will depend in part on the polyisocyanate content and other ingredients present in the second part. The first and second parts may for example be mixed at ratios from about 99:1 to about 1:1.

The disclosed compositions are especially well-suited for application by building component manufacturers at a building component manufacturing site. The resulting coated building components typically will be dried, cured, stored and then shipped to distributors or end users for eventual installation on buildings or other architectural objects or structures. The first and second parts may however be sold to end users and mixed and applied onsite to preinstalled building components, e.g., as paints or stains for use on windows, doors, siding, shutters, trim, moldings, jambs, decking, railings, roofing, walls, floors, ceilings or other surfaces. When sold directly or indirectly to such end users it may also be desirable to provide one or both of the first and second parts as an untinted base paint or stain intended to be mixed with one or more colorants from an array of colorants in order to form a custom-tinted non-infrared-absorptive coating composition. In such case the first and second parts and all colorants in the colorant array preferably contain only non-infrared-absorptive pigments.

The coating compositions may be applied to a variety of substrates including thermoplastic, thermoplastic composite or thermoplastic-clad materials, as well as to other materials including thermoset, thermoset composite, thermoset-clad, wood, impregnated wood, wood-derived and metal materials. The disclosed coating compositions are especially useful for application to mixed-substrate building components containing at least one thermoplastic, thermoplastic composite or thermoplastic-clad material together with another material or materials that are not a thermoplastic, thermoplastic composite or thermoplastic-clad material. For example, many modern prefabricated high performance windows and doors are mixed-substrate building components. Exemplary thermoplastic polymers may for example include vinyl (PVC), polystyrene (PS), thermoplastic polyolefin (TPO) such as polyethylene (PE) and polypropylene (PP), acrylonitrile-butadiene-styrene (ABS), polycarbonate (PC), nylon, polyethylene terephthalate (PET) or other polyesters, and other thermoplastics that will be familiar to persons having ordinary skill in the art. Exemplary thermoplastic composite substrates may include any of the above-mentioned thermoplastic polymers together with reinforcing fillers, strands or woven or nonwoven webs made from materials including fiberglass (e.g., composites made by pultrusion), natural fabrics and fibers (e.g, cotton), carbon fibers and fabrics, wood fibers and various wood byproducts, and other composite reinforcing materials that will be familiar to persons having ordinary skill in the art. Exemplary thermoplastic-clad substrates may include a partial or complete shell containing one or more such thermoplastic polymers or thermoplastic composites and a solid, foamed or hollow core made of wood, metal, plastic or other material that will be familiar to persons having ordinary skill in the art. Exemplary thermoset polymers may be made from cyanate ester resins, epoxy resins, melamine resins, phenol-formaldehyde resins, polyimide resins, urea-formaldehyde resins and vulcanized rubbers. Exemplary metals include aluminum, brass, copper, iron, pot metal, steel, tin and zinc.

Exemplary substrates for use in making the disclosed building components are commercially available from or used by a variety of manufacturers including Accu-Weld, Alcoa Inc., Andersen Corporation, Associated Materials Inc., CertainTeed Corporation, Crane Performance Siding, Comfort Windows, Duxton Windows & Doors, Evans Glass, Gorell Windows & Doors, LLC, Inline Fiberglass Ltd., Jeld-Wen, Inc., Hurd Windows and Doors, Larmco Windows, Marvin Windows and Doors, Masonite International Corporation, Milgard Manufacturing, Inc., MW Manufacturers, Inc., NT Window, Omniglass Ltd., Owens Corning, Peel Plastic Products Ltd., Pella Corporation, Resource Materials Corporation, Rollex Corporation, The Royal Group, Schüco USA L.P., Simonton Building Products, Inc., Sunrise Windows, Ltd., Teel Plastics, Inc., Thermal Industries, Inc., Thermal-Gard Building Products, Inc., Variform, Inc., VEKA AG, VPI Quality Windows, Wallside Windows and Weather Shield Manufacturing, Inc. Other commercially available thermoplastic composite or thermoplastic-clad substrates include FIBREX™ thermoplastic composites and PERMASHIELD™ vinyl-clad building components from Andersen Corporation, DURACAST™ thermoplastic composites from Pella Corporation, FIBERLOC™ thermoplastic composites from PolyOne Corporation, VALOX™ thermoplastic composites from SABIC Innovative Plastics Holding BV, TREX™ polyethylene/wood composites from Trex Company, Inc. and ACCOYA™ acetylated wood from Universal Forest Products, Inc. The substrate may have a bare (viz., unprimed) or previously-coated (e.g., primed or topcoated) surface. The disclosed compositions may be used to replace solvent-borne or aqueous paint systems that may previously have been used on such substrates, e.g., the various CHEMCRAFT™ finishes from Akzo Nobel Coatings Inc., AQUASURTECH™ coatings from AquaSurTech Coating Products, N. A., FLEXACHRON™ finishing systems from PPG Industrial Coatings and POLANE SOLAR™ solar reflective polyurethane enamels from Sherwin-Williams Company.

The disclosed compositions may make it unnecessary to apply an intermediate protective layer prior to application of a protective topcoat. Such intermediate protective layers are sometimes employed to shield substrates from IR-induced heat distortion when a conventional colored protective topcoat atop the substrate absorbs infrared radiation. For example, protective intermediate layers known as “surfacing veils” as often applied to fiberglass composite substrates made by pultrusion so that the substrate will be less likely to undergo heat distortion when topcoated with an infrared-absorptive topcoat. Such intermediate protective layers may be rendered unnecessary when the disclosed coating compositions are employed in place of conventional topcoats.

The coating compositions may be applied using a variety of methods that will be familiar to persons having ordinary skill in the art, including spraying (e.g., air-assisted, airless or electrostatic spraying), brushing, roller coating, flood coating and dipping. The compositions may be applied at a variety of wet film thicknesses. Preferably the wet film thickness is such as to provide a dry film thickness of about 13 to about 260 μm (about 0.5 to about 10 mil) and more preferably about 25 to about 75 μm (about 1 to about 3 mil) for the cured coating. The applied coating may be cured by allowing it to air dry or by accelerating curing using a variety of drying devices (e.g., ovens) that will be familiar to persons having ordinary skill in the art. Preferred heating temperatures for curing the coating compositions are about 50° to about 65° C., and more preferably about 60° to about 65° C., and preferred heating times are at least three minutes and less than 60 minutes, less than 45 minutes, less than 30 minutes, less than 15 minutes, less than 10 minutes, less than six minutes or less than five minutes. The heating time will tend to decrease with increased temperature, increased airflow or decreased humidity.

The disclosed coated articles may be used for a variety of purposes. Representative end-use applications include architectural elements such as windows, doors, siding, shutters, trim, moldings, jambs and other elements used on or around openings; railings; furniture; cabinetry; walls; ceilings; decking and other flooring including engineered flooring, roofing, and marine trim or other building components.

The cured coating compositions may be evaluated using a variety of tests including American Architectural Manufacturers Association (AAMA) Voluntary Specifications AAMA 615-05 (for plastic profiles), 623-07 (for thermoset profiles), 624-07 (for fiber reinforced thermoset profiles) and 625-07 (for fiber reinforced thermoset profiles), as well as Window & Door Manufacturers Association (WDMA) Test Methods TM-11-06 (factory applied pigmented primer coatings for wood and wood cellulosic composites used for millwork) and TM-12-06 (factory applied pigmented finish coatings for wood and wood cellulosic composites used for millwork).

The invention is further illustrated in the following non-limiting examples, in which all parts and percentages are by weight unless otherwise indicated.

### Example 1

The Part A ingredients shown below in Table 1 were combined and mixed to provide a uniform dispersion. The Part A dispersion was then mixed with the Part B polyisocyanate to provide a black-tinted non-infrared-absorptive coating composition:

TABLE 1

| | Example |
|---|---|
| Ingredient | 1, Parts |
| Part A | |
| Grind: | |
| Water | 129 |
| BENTONE EW Rheology Modifier | 3 |
| CELLOSIZE QP-09-L Rheology Modifier | 2 |
| TEGO FOAMEX 810 Defoamer | 3 |
| HYDROPALAT 44 Dispersant | 7 |
| TAMOL 731 A Dispersant | 3 |
| Ammonia | 0.3 |
| EFKA 4510 Surfactant | 4 |
| T-DET N 10.5 Surfactant | 3 |
| Soy Lethicin | 3 |
| SHEPHERD ARTIC Black 30C940 Pigment | 261 |
| SYLOID 74 Flattening Pigment | 5 |
| VANSIL W 30 Flattening Pigment | 1 |
| POLYPHASE 663 Biocide | 5 |
| KATHON LX Preservative | 1.5 |
| BORCHER LH 10 Catalyst | 8 |
| Letdown: | |
| Water | 68 |
| EPS-2771 Acrylic Emulsion | 485 |
| KYNAR AQUATEC ARC Fluoropolymer Emulsion | 40 |
| Final Ingredients: | |
| TINUVIN 292HP UV Absorber | |
| TINUVIN 1130 Hindered Amine Light Stabilizer | 10 |
| DOWANOL DPM Cosolvent | 7 |
| Water | 20 |
| MICHEM Emulsion 32535 Wax | 8 |
| BYK 348 Wetting Agent | 1 |
| ACRYSOL RM-12W Rheology Modifier | 0.5 |
| ACRYSOL RM-2020 NPR Rheology Modifier | 3 |
| Total Part A | 1086.3 |
| Part B | |
| BAYHYDUR 304 water-dispersible polyisocyanate | 43.5 |
| Non-HAPS solvents | 2.0 |
| Total Part B | 45.5 |

The Example 1 coating composition was applied using a variety of techniques (including air-powered, airless and electrostatic spray) to a variety of substrates (including vinyl, vinyl-wood composites, vinyl-clad wood, fiberglass pultrusion, reaction injection molded urethane foam, wood and engineered wood) at wet film thicknesses sufficient to provide an about 50 to about 260 μm (about 1.5 to about 10 mil) dry film thickness, and cured by air drying for 1 to five minutes depending on the film build followed by heating at 60 to 65° C. for 8 to 10 minutes. Depending on the chosen substrate, the cured coatings were evaluated according to American Architectural Manufacturers Association (AAMA) Voluntary Specification AAMA 615-05 (for plastic profiles), AAMA 625-07 (for Fiber Reinforced Thermoset Profiles) and Window & Door Manufacturers Association (WDMA) Test Method TM-12-06. Based on xenon accelerated weathering tests, two year outdoor exposure tests, and tests employing successive daytime UV exposure and nighttime moisture exposure, the coatings should pass all the Weathering requirements in the AAMA specifications and all the Weather Exposure requirements in the WDMA specification. The coatings also passed all the other laboratory tests in these AAMA and WDMA specifications, demonstrating superior performance in very demanding applications.

In addition to the disclosed two-part aqueous coating composition whose first part comprises a waterborne active hydrogen-functional latex binder and whose second part comprises a water-dispersible polyisocyanate, wherein one or both of the first and second parts comprise non-infrared-absorptive colored pigment, and wherein a mixture of the first and second parts coated atop a vinyl substrate will cure to form a vinyl-adherent, infrared-reflective colored protective film, the present invention also includes such a coating composition:
wherein the pigment comprises a single or mixed metal oxide;
wherein the mixture contains 8 to 50 wt. % pigment based on total solids;
wherein the mixture is substantially free of infrared-absorptive colored pigments;
wherein the mixture contains 20 to 70 wt. % active hydrogen-functional latex binder solids based on total solids;
wherein the mixture contains 1 to 10 wt. % polyisocyanate based on total solids;
further comprising a non-hydroxyl-functional resin;
further comprising cosolvent, plasticizer, catalyst, rheology modifier, surfactant, dispersant or mixture thereof;
wherein the cured protective film has an L* value less than 60;
wherein the cured protective film has a total solar reflectance of at least 10 as measured using ASTM E-971-88 (Reapproved 2003); or
wherein the cured protective film reduces susceptibility of infrared-illuminated thermoplastic building components to heat distortion compared to an otherwise similar film made without the non-infrared-absorptive colored pigment.

In addition to the disclosed coated building component comprising a thermoplastic, thermoplastic-containing or thermoplastic-clad substrate having thereon a wet coating comprising a waterborne mixture of active hydrogen-functional latex binder, water-dispersible polyisocyanate and non-infrared-absorptive colored pigment, which coating will cure to form a substrate-adherent and infrared-reflective colored protective film, the present invention also includes such a building component:
comprising a vinyl substrate;
comprising a polystyrene, thermoplastic polyolefin, acrylonitrile-butadiene-styrene, polycarbonate, nylon or polyester substrate;
comprising a thermoplastic composite substrate;
comprising a fiberglass substrate;
wherein the substrate further comprises thermoset polymer;
wherein the pigment comprises a single or mixed metal oxide;
wherein the mixture contains 8 to 50 wt. % pigment based on total solids;
wherein the mixture is substantially free of infrared-absorptive colored pigments;
wherein the mixture contains 20 to 70 wt. % active hydrogen-functional latex binder solids based on total solids;
wherein the mixture contains 1 to 10 wt. % polyisocyanate based on total solids;
wherein the mixture further comprises a non-hydroxyl-functional resin;
wherein the mixture further comprises cosolvent, plasticizer, catalyst, rheology modifier, surfactant, dispersant or mixture thereof;
wherein the cured protective film has an L* value less than 60;
wherein the cured protective film has a total solar reflectance of at least 10 as measured using ASTM E-971-88 (Reapproved 2003);
wherein the cured protective film reduces susceptibility of infrared-illuminated thermoplastic building components to heat distortion compared to an otherwise similar film made without the non-infrared-absorptive colored pigment;
wherein the cured protective film is a topcoat;
comprising a window;
comprising a door; or
comprising siding, trim, decking, railing, roofing or a wall, floor or ceiling.

In addition to the disclosed method for coating building components, which method comprises: (a) applying to a thermoplastic, thermoplastic composite or thermoplastic-clad substrate a wet coating comprising a waterborne mixture of active hydrogen-functional latex binder, water-dispersible polyisocyanate and non-infrared-absorptive colored pigment; and (b) curing the coating to form a substrate-adherent and infrared-reflective colored protective film, the present invention also includes such a method:
comprising applying the mixture to a vinyl substrate;
comprising applying the mixture to a polystyrene, thermoplastic polyolefin, acrylonitrile-butadiene-styrene, polycarbonate, nylon or polyester substrate;
comprising applying the mixture to a thermoplastic composite substrate;
comprising applying the mixture to a fiberglass substrate;
comprising applying the mixture to a substrate comprising thermoset polymer;
wherein the pigment comprises a single or mixed metal oxide;
wherein the mixture contains 8 to 50 wt. % pigment based on total solids;
wherein the mixture is substantially free of infrared-absorptive colored pigments;
wherein the mixture contains 20 to 70 wt. % active hydrogen-functional latex binder solids based on total solids;
wherein the mixture contains 1 to 10 wt. % polyisocyanate based on total solids;
wherein the mixture further comprises a non-hydroxyl-functional resin;
wherein the mixture further comprises cosolvent, plasticizer, catalyst, rheology modifier, surfactant, dispersant or mixture thereof;
wherein the cured protective film has an L* value less than 60;
wherein the cured protective film has a total solar reflectance of at least 10 as measured using ASTM E-971-88 (Reapproved 2003);
wherein the cured protective film reduces susceptibility of infrared-illuminated thermoplastic building components to heat distortion compared to an otherwise similar film made without the non-infrared-absorptive colored pigment;
wherein the cured protective film is a topcoat;
comprising applying the mixture to a window;
comprising applying the mixture to a door; or
comprising applying the mixture to siding, trim, decking, railing, roofing or a wall, floor or ceiling.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

We claim:

1. A two-part aqueous coating composition whose first part comprises a waterborne active hydrogen-functional latex binder and whose second part comprises a water-dispersible polyisocyanate, wherein one or both of the first and second parts comprise non-infrared-absorptive colored pigment, and wherein a mixture of the first and second parts coated atop a vinyl substrate will cure to form a vinyl-adherent, infrared-reflective colored protective film.

2. A composition according to claim 1 wherein the pigment comprises a single or mixed metal oxide.

3. A composition according to claim 1 wherein the mixture contains 8 to 50 wt. % pigment based on total solids.

4. A composition according to claim 1 wherein the mixture is substantially free of infrared-absorptive colored pigments.

5. A composition according to claim 1 wherein the mixture contains 20 to 70 wt. % active hydrogen-functional latex binder solids based on total solids.

6. A composition according to claim 1 wherein the mixture contains 1 to 10 wt. % polyisocyanate based on total solids.

7. A composition according to claim 1 further comprising a non-hydroxyl-functional resin.

8. A composition according to claim 1 further comprising cosolvent, plasticizer, catalyst, rheology modifier, surfactant, dispersant or mixture thereof.

9. A composition according to claim 1 wherein the cured protective film has an L* value less than 60.

10. A composition according to claim 1 wherein the cured protective film has a total solar reflectance of at least 10 as measured using ASTM E-971-88 (Reapproved 2003).

11. A composition according to claim 1 wherein the cured protective film reduces susceptibility of infrared-illuminated thermoplastic building components to heat distortion compared to an otherwise similar film made without the non-infrared-absorptive colored pigment.

12. A coated building component comprising a thermoplastic, thermoplastic-containing or thermoplastic-clad substrate having thereon a wet coating comprising a waterborne mixture of active hydrogen-functional latex binder, water-dispersible polyisocyanate and non-infrared-absorptive colored pigment, which coating will cure to form a substrate-adherent and infrared-reflective colored protective film.

13. A component according to claim 12 comprising a vinyl substrate.

14. A component according to claim 12 comprising a polystyrene, thermoplastic polyolefin, acrylonitrile-butadiene-styrene, polycarbonate, nylon or polyester substrate.

15. A component according to claim 12 comprising a thermoplastic composite substrate.

16. A component according to claim 12 comprising a fiberglass substrate.

17. A component according to claim 12 wherein the substrate further comprises thermoset polymer.

18. A component according to claim 12 wherein the cured protective film is a topcoat.

19. A component according to claim 12 comprising a window, door, siding, trim, decking, railing, roofing or a wall, floor or ceiling.

20. A method for coating building components, which method comprises:
a) applying to a thermoplastic, thermoplastic composite or thermoplastic-clad substrate a wet coating comprising a waterborne mixture of active hydrogen-functional latex binder, water-dispersible polyisocyanate and non-infrared-absorptive colored pigment; and
b) curing the coating to form a substrate-adherent and infrared-reflective colored protective film.
